(19) United States
(12) Patent Application Publication
(10) Pub. No.: US 2003/0016182 A1
(43) Pub. Date: Jan. 23, 2003

(54) Array for the transmission of electrical signals between moving units at a reduced number of paths

(76) Inventor: Georg Lohr, Eichenau (DE)

Correspondence Address: ST. ONGE STEWARD JOHNSTON & REENS, LLC, 986 BEDFORD STREET, STAMFORD, CT, 06905-5619, US

(21) Appl. No.: 10/158,330

(22) Filed: May 30, 2002

Related U.S. Application Data
(63) Continuation of application No. PCT/DE00/04263, filed on Nov. 30, 2000.

(30) Foreign Application Priority Data
Nov. 30, 1999 (DE) 199 57 621.1

(51) Int. Cl. H01Q 21/00

(52) U.S. Cl. 343/853

(57) ABSTRACT

What is described here is an array for the transmission of electric signals and/or energy between units between units or parts mobile relative to each other, consisting of at least two electrical conductors matched with the trajectory of the movement on the first part and further parts in galvanic or at least capacitive or inductive contact, respectively, with these conductors.

The inventive array is characterized by the provision that at least one of said electrical conductors, which serves at the same time for the transmission of control and/or data signals, is galvanically connected via a filter to said protective conductor such that it performs also the drain function of said protective conductor.

This application is a continuation of pending International Application No. PCT/DE00/04263 filed Nov. 30, 2000, which designates the United States and claims priority of German Patent Application No. 199 57 621.1 filed Nov. 30, 1999.

### FIELD OF THE INVENTION

The present invention relates to an array for the transmission of electric signals and/or energy between moving units that may be disposed along an optional trajectory and are in galvanic or at least capacitive or inductive contact, respectively, with each other.

### PRIOR ART

Electric signals or electric energy must frequently be transmitted between units or parts moving relative to each other. A common method used to this end is the use of sliding paths and slip rings. Here, the signal or the energy, which is supplied on a linear conductor or even a conductor disposed on a circular trajectory, is derived by means of a mobile tap. Such taps may consist of contact springs or even graphite elements permitting an appropriate galvanic contact. It is equally possible to transmit signals or energy by capacitive or inductive means, respectively, as is described in the German Patent Application P 28 45 438. For the sake of clarity, reference will be made the terms “Signal” or “energy” in the following description. Moreover, the term “channel” denotes a complete signal channel that is capable of transmitting information simultaneously and that consists hence of at least one forward conductor and one return conductor. It is definitely possible that several channels share a common return conductor. What is essential is source and the load or signal sink, respectively. The term “protective conductor” applies here also to ground conductors.

Transmission systems employed in practical operation are normally provided with some paths for power supply of the moving means as well as with several paths for the transmission of control signals. As a rule, the energy is supplied via mains voltage lines connected to the local utility network (230 V, 400 V). It occurs more and more frequently that DC intermediate circuits galvanically connected to the network are used. In such a case, the AC power network is transmitted into a DC power network by means of a boost converter serving to correct the load factor. Both the AC power network and the DC intermediate circuit require a connection via a protective conductor between the mobile unit and the stationary unit for safety reasons. The current load capacity of the protective conductor connection and hence their conductor or slip path cross-section must correspond to the cross-sections of the energy supply paths. The energy supply paths as such are frequently designed for high currents and are therefore provided with large cross-sections and a high number of contact springs or graphite elements. Merely the expenditure in terms of material for the protective conductor path as well as their contact media gives rise to a rather substantial cost expenditure. Apart therefrom, additional space is required for this path. In the simplest case of a dual-conductor system with a protective conductor, this protective conductor path incurs costs higher by 50% at a space requirement equally increased by 50%. For the purpose of a space-saving and low-cost transmission technology it were therefore desirable to implement the function of the protective conductor, however without requiring a separate transmission path to this end.

### PRIOR ART

The present invention is based on the problem of improving an array for the transmission of electric signals and/or energy between moving units that may be disposed along an optional trajectory or path of movement, respectively, and are in mutual galvanic or at least capacitive or inductive contact, respectively, in such a way that the electrical safety of the array can be ensured without the use of a discrete path for the exclusive function of the protective conductor.

The solution to this problem is defined in claim 1. Expedient improvements are the subject matters of the dependent claims.

In correspondence with the invention, a device according to the introductory clause of claim 1 is so designed that at least one path for the transmission of control and/or data signals can perform the safety function of the protective conductor. To this end, a filter connects the protective conductor terminal to the transmission paths. The filter has the functions of low-frequency coupling of the protective conductor to the transmission paths and of decoupling the control signals from the protective conductor. To this end, the filter in the current path between the transmission paths and the protective conductor as such presents a low-pass characteristic that lets DC fractions and particularly the low-frequency fractions corresponding to the mains frequency pass. The filter must be of such a low impedance within this frequency range and present such a high current load capacity that it will comply with the applicable safety regulations. In the other path, between the signal transmission paths and the signal sources or sinks, respectively, the filter presents a characteristic that lets the mostly high-frequency control signals pass freely. The filters between the signal transmission paths and the protective conductor have the function of decoupling the individual signal transmission paths for the control signals from each other and to couple them for low-frequency leakage currents flowing via the protective conductor. For this reason, they must be so dimensioned that they have a sufficiently high attenuation for the frequencies corresponding to the control signals. Moreover, these filters are intended to prevent high-frequency fractions from arriving from the control signals into the protective conductor of the mains supply system and from being irradiated by the protective conductor in an undesirable manner.

Another advantage of the inventive array resides in the further space savings, compared against double insulated systems. In such double insulated systems, the insulating provisions on the sliding contacts between the power transmission paths and the signal transmission paths are equal to the double rated isolation distance. When the signal transmission paths are now connected to the protective conductor directly, in correspondence with the invention, this distance can be reduced again to its rated value, i.e. to half of the value in a double insulation. As a result, further space savings are achieved whilst wear is reduced due to the reduced consumption of material.

Another advantage of the inventive array is the higher redundancy. In a sliding contact system of the conventional structure, a low-impedance transition through the sliding contact is never ensured with 100% reliability. Hence one cannot preclude, not even in the case of a fault, that the protective conductor function is inappropriate or does not at all exist as a result of contact trouble that may be caused by corrosion, contact bounce or a mechanical defect. In the inventive array, the protective conductor function is distributed to several sliding contact arrays so that at least one or several of these sliding contact arrays can receive the leak current with a high probability. The inventive array hence offers a substantially higher degree of safety. Moreover, an inventive sliding contact array has, as a rule, a substantially higher current load capacity than a conventional protective conductor contact so that in the case of a fault or a defect a lower contact voltage occurs on the defect component of the system. The higher current load capacity derives from the common dimensioning usual in sliding contact arrays.

This will be explained more clearly by a simple example:

A typical sliding contact array in the case of a simple slip ring for a computer tomograph is assumed to have two paths for energy transmission with a maximum current load capacity of 80 A and four further signal transmission paths for the transmission of control signals in pairs. Conventional silver graphite elements with a cross-sectional area of 5×4 mm² on brass paths are used to transmit the current. The current load capacity of such a silver graphite element amounts to 20 A. For safety reasons, 6 of these silver graphite elements are used at a time for the power lines. 4 of these graphite elements are used for the control signal transmission path, which are connected in parallel per path, so as to achieve a reduction of contact noise and hence an improvement of the quality in signal transmission due to the parallel connection. With these provisions, the increase of the current load capacity to roughly 80 A per path constitutes a positive secondary effect. When now, in correspondence with an inventive array, these 4 control signal transmission paths are connected in parallel for implementing the protective conductor function this new overall protective conductor arrangement has a current load capacity of 240 A and a correspondingly low contact resistance. As a consequence, this system offers a substantially higher level of safety than a system designed in correspondence with the conventional rules, in which an additional protective conductor path with 6 silver graphite elements is provided. The dimensioning is very similar in the majority of contacting systems, too, which correspond to prior art, such as gold sprig wire contacts or even silver tape contacts.

In a particularly expedient embodiment of the invention, the signal branches between the protective conductor and the signal transmission paths merely in the filter are provided with the low-pass characteristic described above. The control signal sources or sinks, respectively, are connected directly to the signal transmission paths. Such an arrangement can be realized at particularly low costs whilst it enables yet an interference-proof signal transmission. When DC or low-frequency signals of a higher intensity are transmitted via sliding paths the contact noise of the sliding contacts gives rise to a high-frequency voltage drop on these paths, which cannot be neglected. It was possible to prove in extensive test series amplitudes up into the voltage range at frequencies up to 200 MHz. These signals are superimposed on the control signals. The advantage of the array described here resides, however, in the aspect that normally no or only a very slight current flows via the protective conductor. Hence, not even the voltage drops occurring as a result of contact noise lead to substantial signal interference or noise in the control signals. Noticeable current intensities and hence voltage drops to a non negligible extent may occur on the signal transmission paths merely in the case of a defect or trouble situation in the system, in which a leak current flows through the protective conductor.

In a further expedient embodiment of the invention additional filter elements are provided in the signal branch of the filter between the control signal sinks and sources or the signal transmission paths, respectively, which filter elements pass a narrow band of the transmission frequency range of the control signals whilst they stop or reject the noise frequency ranges of contact noise or of the low-frequency mains voltages, respectively.

According to another embodiment provided in accordance with the invention, the signal transmission path of the filter comprises at least one inductor between the protective conductor terminal and the signal transmission paths, which inductor includes at least two windings that are wound in opposite directions so that the magnetic fields of the windings will extinguish each other for protective conductor currents. This arrangement is particularly expedient when symmetrical signals (differential signals) are transmitted on two signal transmission paths. Hence, a particularly high inductance and hence a particularly strong filter effect are achieved for the differential signals whilst the effective inductance approaches zero for a common signal, such as the protective conductor leak current, so that the conductors are suitable for carrying off protective conductor currents over a wide bandwidth.

According to a further expedient embodiment of the invention, a symmetry transformer is provided in the path of the filter between the signal transmission paths and the signal source or sink, respectively, in the case of a symmetrical signal transmission. This symmetry transformer ensures a wide-band high suppression of non-symmetrical signals such as those occurring in the case of a high leak current through the protective conductor on the sliding paths. Voltage drops caused by contact noise are equally suppressed over a wide range because they occur only as non-symmetrical signals, too.

In a further expedient embodiment of the invention, the filter includes a simple ferrite or iron core as an essential filter element between the protective conductor and the sliding contacts, which core encloses the protective conductor feeders either separately or, in the case of a symmetrical signal transmission, in opposite directions.

### BRIEF DESCRIPTION OF THE DRAWINGS

In the following, the present invention will be described in more details by embodiments, with reference to the drawing wherein

FIG. 1 illustrates an embodiment with a linear sliding path system;

FIG. 2 represents the savings in space and costs, which are achieved with the inventive arrangement;

FIG. 3 shows a particularly preferred embodiment, and

FIGS. 4-7 illustrate further embodiments.

### DESCRIPTION OF EMBODIMENTS

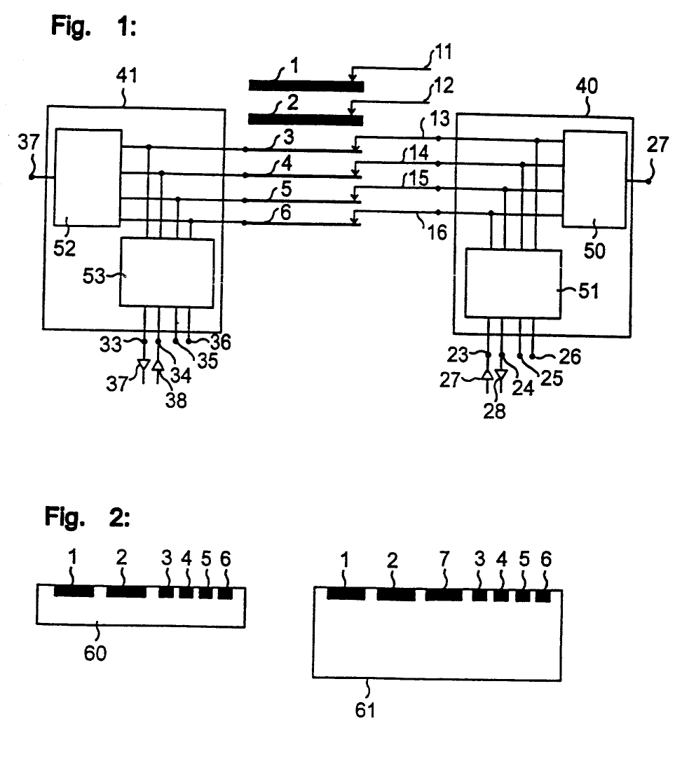

FIG. 1 illustrates an inventive array by the example of a linear sliding path system. The principle of the invention can, of course, also be applied to a rotationally symmetrical slip ring or even a transmission path with an optional trajectory. The sliding path system consists of the sliding paths (1 . . . 6) with the corresponding sliding contacts (1 . . . 16). In the system described here by way of example, the sliding paths (1, 2) as well as the associated sliding contacts (11, 12) are provided with a particularly high voltage-proof characteristic and a particularly high current load capacity for power transmission. All other sliding paths and sliding contacts are exclusively designed for signal transmission for control signals. The sliding paths for the control signals well as the sliding contacts are connected via the filter units (40) or (41). The first filter (40) comprises a filter block (50) connecting the protective conductor terminal (27) with the signal transmission paths. Moreover, it includes a second filter block (51) that connects the signal transmission paths with the corresponding terminals for the control signals (23 . . . 26). Optional signal sources or sinks, respectively (27, 28) are connected to these terminals. A similar arrangement is disposed on the other side of the sliding contact system. Here, the filter (41) with a first filter unit (52) is provided for connecting the protective conductor terminal (37) to the signal transmission paths whilst a second filter unit (53) is provided for connecting the signal sources or sinks, respectively (37, 38) via the outputs (33 . . . 36) to the sliding paths for signal transmission.

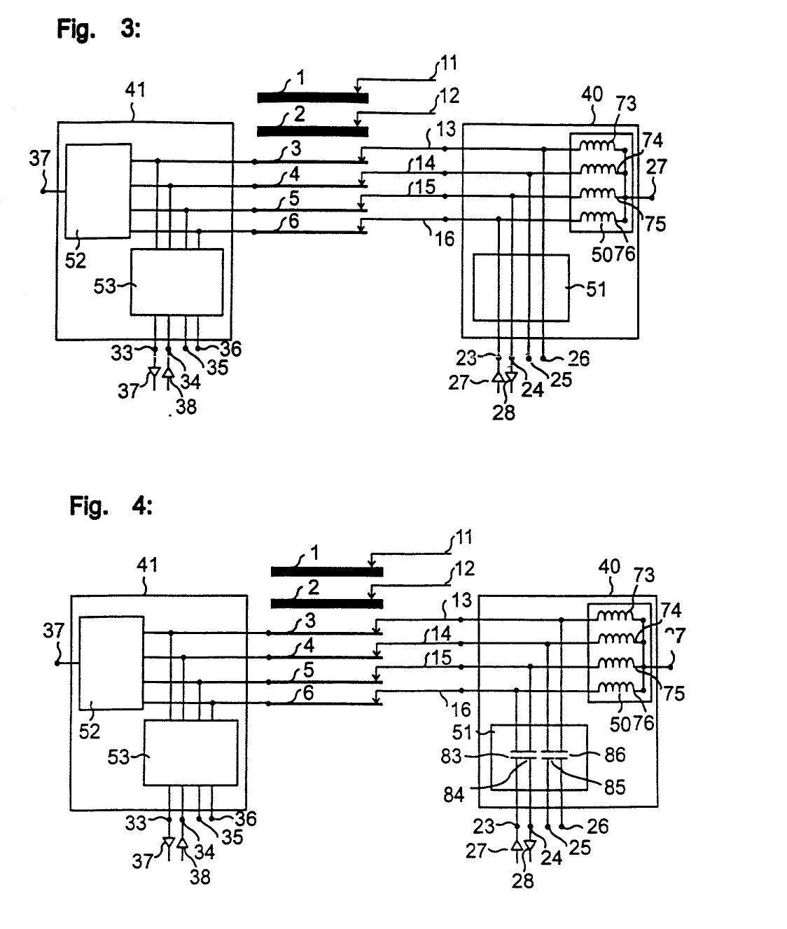

FIG. 2 serves to illustrate the savings in space and costs in an inventive array. It shows the cross-section of a typical sliding contact module (60) that includes the sliding paths (1, 2) for energy transmission and (3 . . . 6) for signal transmission, as well as a corresponding sliding path module (61) wherein an additional protective conductor (7) is provided that completes the power transmission paths (1, 2) or signal transmission paths (3 . . . 6), respectively). In order to achieve also a sufficient mechanical stability in the module (61) extended by the additional protective conductor path it is necessary that the thickness of the module must be increased. The comparison of sizes of the two illustrates shows, at the first glance, the reduced quantity of material used, due to the omission of the protective conductor path, as well as a substantially reduced consumption of supporting material.

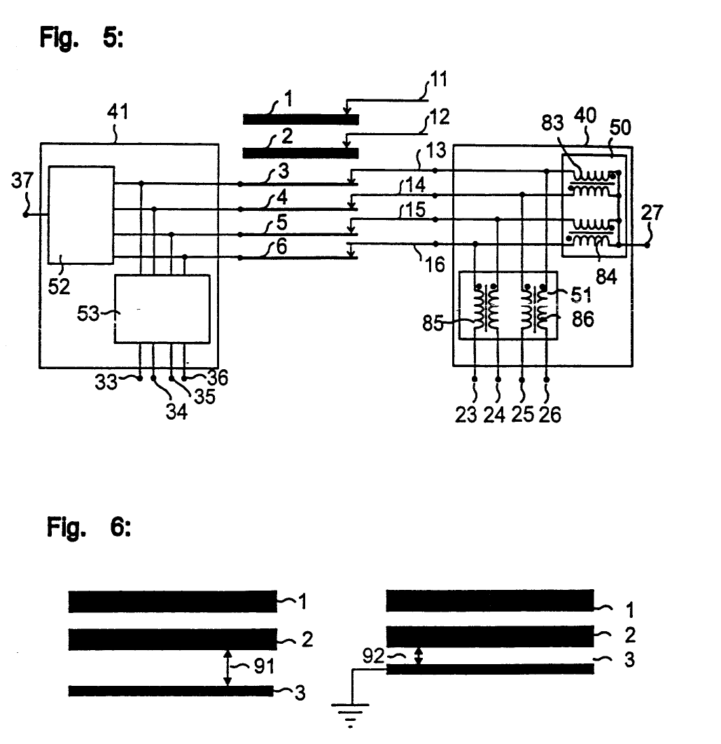

FIG. 3 shows a particularly expedient system wherein the first filter block between the protective conductor terminal and the signal transmission path comprises merely inductors (73 . . . 76) for decoupling the signal transmission paths from each other an the signal transmission paths from the protective conductor. The connections between the signal transmission paths and the control signal sources or sinks, respectively, are realized here with galvanic means.

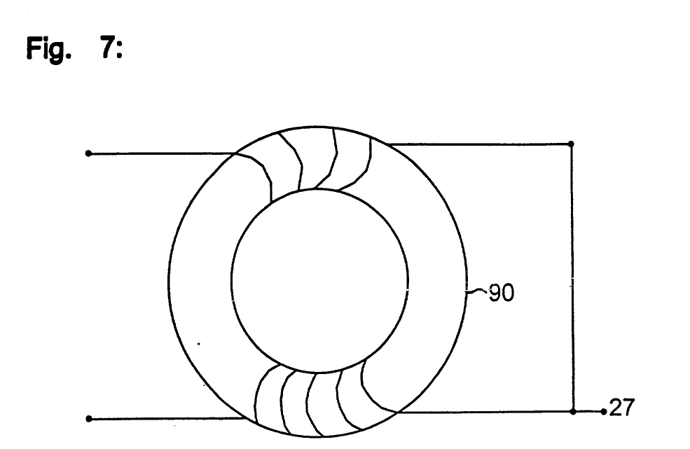

FIG. 4 illustrates a further expedient system wherein, in addition to the embodiment described before, the signal transmission paths between the signal sources and sinks as well as the signal transmission paths are decoupled by capacitors (83 . . . 85). It is equally a matter of fact that decoupling can be realized by means of transformers.

FIG. 5 shows another embodiment that can be employed with particular advantage for the transmission of symmetrical signals via the signal transmission paths. Here, by way of example, a first symmetrical signal is transmitted via the paths 3 and 4 whilst a further symmetrical signal is transmitted via the paths 5 and 6. A transformer (83, 84) is used in the filter unit (50) between the protective conductor terminal and the control signal transmission paths, at least for each of these symmetrical signal transmission paths, in which transformer both windings are wound in opposite directions. This transformer offers a particularly high level of suppression of symmetrical signals. At the same time, this example illustrates how a particularly high level of noise suppression can be achieved in the control signals. To this end, a symmetry transformer (85, or (86), respectively, must be employed for each of the control signal transmission paths. These symmetry transformers suppress all non-symmetrical signal fractions in the manner described above, which may have occurred as a result of low-frequency leak currents of the protective conductor or also due to voltage drops caused by contact noise.

FIG. 6 shows the space savings achieved with the inventive arrangement, compared against a system including a double insulation system. In the first illustration, an increased safety distance (91) must be provided between the two power transmission paths (1, 2) and the signal transmission path (3), which distance corresponds generally to twice the isolation distance. The second system, which corresponds to the subject matter of the invention, shows that only the regular isolation spacing (92) must be observed between the two power transmission paths (1, 2) and the signal transmission path (3).

Finally, FIG. 7 shows a particularly expedient design of the transformer (83) for coupling the protective conductor to the signal transmission paths. In this case, an iron or ferrite core, which consists of a toroid core (90) in the simplest case, is surrounded by a small number of windings of the protective conductor cable.

1. Array for the transmission of electric signals and/or energy between units between units or parts mobile relative to each other, consisting of at least two electrical conductors matched with the trajectory of the movement on the first part and further parts in galvanic or at least capacitive or inductive contact, respectively, with these conductors,
characterized in that at least one of said electrical conductors, which serves at the same time for the transmission of control and/or data signals, is galvanically connected via a filter to said protective conductor such that it performs also the drain function of said protective conductor.

2. Array according to claim 1,
characterized in that at least two electrical conductors, whereof at least one serves to transmit control and/or data signals, are galvanically connected via filters to said protective conductor such that they can perform also the drain function of said protective conductor.

3. Array according to claim 1 or 2,
characterized in that said filter comprises an inductor for coupling said protective conductor to at least one of said electrical conductors.

4. Array according to any of the claims 1 to 3,
characterized in that said filter comprises at least one inductor for each electrical conductor that is to be used for the transmission of the protective conductor current, which inductor is connected by one end to said electrical conductor and by the other end to said protective conductor.

5. Array according to any of the claims 1 to 4,
characterized in that for coupling said protective conductor, said inductor consists of a ferrite or iron core around said protective conductor.

6. Array according to any of the claims 1 to 5,
characterized in that in the case of a symmetrical transmission of differential signals on the conductors used for the transmission of the protective conductor current, said inductor for coupling said protective conductor consists of two windings wound in opposite directions.
